(19) United States
(12) Patent Application Publication
(10) Pub. No.: US 2024/0354777 A1
(43) Pub. Date: Oct. 24, 2024

(54) Computer Enabled System Matching Child Related Services to Service Providers

(71) Applicant: Olivia Rutman, Carlsbad, CA (US)

(72) Inventor: Olivia Rutman, Carlsbad, CA (US)

(21) Appl. No.: 18/645,341

(22) Filed: Apr. 24, 2024

Related U.S. Application Data
(60) Provisional application No. 63/461,407, filed on Apr. 24, 2023.

(51) Int. Cl. G06Q 30/018; G06Q 50/22

(52) U.S. Cl. CPC G06Q 30/018; G06Q 50/22

(57) ABSTRACT

A computer implemented system matching children needing professional services to service providers of such services is provided. The system allows for enrollment of children seeking services and matching of each child requiring a particular service to service providers identified as providing it. The system operates to employ gathered child information concerning each child to populate patient forms required by service providers. It also allows for a sharing of services of one service provider among multiple children.

### BACKGROUND OF THE INVENTION

### 1. Field of the Invention

The invention herein disclosed relates generally to children and professional services such children may require. More particularly, it relates to a system employing software running on a computer accessible over a network which operates to match desired services, which a child may need, to service providers for such in a defined geographic area, as well as providing communications therebetween.

### 2. Prior Art

There are numerous websites available that are adapted to help parents and caregivers of children to find service providers needed for their child. Such computer enabled systems operated, conventionally, to match the specific requirement of the child to a provider of services or products relating to the input requirement. However, such child and service matching firms, conventionally, are very limited in operation as to the provision, through the site itself, of the availability of potential service providers which are determined to match those needed by the parent or caretaker for the child. However, most such service matching platforms do not list the providers contact information and require users to message the potential providers through the site.

With respect to the above, before explaining at least one preferred embodiment of the system herein for matching desired services and products for a child to providers for such, it is to be understood that the system herein is not limited in its application to the details of employment and to the arrangement of the components or the steps set forth in the following description or illustrated in the drawings. The various software-enable methods and steps of the herein disclosed child and provider matching service is capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other child and service provider matching and communication systems. It is important, therefore, that the embodiments, objects and claims herein, be regarded as including such equivalent construction and methodology insofar as they do not depart from the spirit and scope of the present invention.

### SUMMARY OF THE INVENTION

The disclosed system herein provides for the real time and ongoing assessment and matching of the needed services or products for a child to a provider of such. Where service providers are matched and communicated to the inquiring parent or caretaker of a child, they may be listed by geographic locale in order to give the inquiring party local providers.

In addition to helping match and connect the respective professional service needs of a child to known providers or such, the system herein provides additional actions for the convenience of both the parent and caretaker and the service providers. To that end, the system herein provides all parties the ability for ongoing electronic communication by email or text or by secured confidential communications within the application which will run on a computer or smartphone.

In another step of the system herein, which will provide ease of use to both providers and inquiring parents and caretakers, the system herein will provide steps to lighten the administrative tasks of the service providers, as well as to lessen or remove the need for repetitive input of information by the parent or caretaker of a child.

Preferred in all modes of the system herein is the provision of an online patient or child application template that has numerous different fields thereon for the input of information concerning the child. The patient template is configured to capture the information conventionally required by most service providers prior to an appointment or visit. This template will be configured with sections or fields for information input, whereby the parent or caregiver of the child can input the requested information for each section.

In an especially preferred mode of the system herein, this patient information template may be customized for each service provider. In this fashion the template can be customized for each provider to capture the fields which that respective provider requires to review candidates and thereby determine if they are a good fit for their facility. To that end, each service provider may be provided the opportunity to review the standard patient information template, provided by the system, and to correlate or match each respective section thereof to a section or information input area of the patient information form of that service provider.

This online enrollment system can also operate to populate the enrollment forms required for certain licensed providers, such as schools and daycare and to also populate the enrollment process and forms based on the requirements of the state the user and/or provider resides within. Thus, in an especially preferred mode of the system, the appropriate enrollment forms for the state in which the provider operates are provided. In an ongoing operation, the system will maintain updated databases on such enrollment forms to ensure that users submit, and providers have, the most up to date and accurate enrollment forms based on the registered state.

The system, with the input of the service provider as to the sections on their respective client or patient questionnaire which correlate to the sections of the patient template, will populate the sections of the patient questionnaire of each respective provider with the information input to the system provided template. This step operates to both reduce the number of forms that the parent or caretaker must fill in for each provider and reduces the administrative work needed by the provider, by electronically filling in their respective patient forms with the requisite information for their office.

Additionally and preferably provided by the system herein is a queue system or wait list management system. This step is preferred as a tool when chosen service providers have no appointment openings available for a desired time slot, users can add themselves to or remove themselves from a respective wait list of a specific provider. The wait list step of the system will, on an ongoing basis, continuously update the parent or caregiver user as to their current position or number on the respective wait list for a chosen service provider. Additionally, chosen service providers may with a single input such as a click of a button on a graphic interface, determine if a user is still interested in their services. Parent users on such a wait list in addition to being able to continuously review their position thereon may choose to remove themselves. This insures full transparency to the system for all users and service providers.

Thereafter, in another step of the system, the service provider may invite a user on the waiting list to apply or enroll for the providers services. Further, prior to initiating an invite, the service provider may remove a user from the wait list, re-order a user position on the wait list, or they may view the user's profile prior to issuing an invitation to the user to apply or enroll for services.

In addition to populating the required patient or new client forms of the providers with the correlating information from the system provider form for users such as parents, the system herein can include a step inputting other authorized parties. This will allow the parent to add legal guardians of children or other parents or authorized persons or medical contacts for the child.

These input additional authorized parties can then be included into the providers form, thereby eliminating the duplicative step of having to add such to the form of each system provider.

Another step in the system may include in the system provided template for the child an area for inclusion of a health history of the child. Once this health information is input, the system can either send the health information 39 to the chosen service provider or the system may send it by an auto-fill of the correlating sections of respective service providers new client or patient form with this information.

Where state laws or provider forms require a signature from the parent or guardian, the system herein can employ an online form such as DocuSign to allow users to e-Sign forms that require a signature. This step can be repeated as necessary.

Additionally preferred, to aid in reducing the enrollment workflow for both user and provider, after the parent or other user e-Signs the enrollment forms, they will be given the option to upload additional documents which are required for enrollment. To that end, a step, providing for the communication of the child's vaccination records, a completed and signed physician's report on the child, and the provider's signed contract may be provided. This insures that all forms relating to enrollment are sent to the provider in one consolidated package.

With the system-provided patient information template being filled in once, should the parent or guardian need to enroll the child to a different provider at a later date, all of the information will have been saved to the database of the system provider computer system. As such, all the parent or guardian needs to do is to update the information in any field of the system template correlating to the child which has changed. Thereafter, the correlating areas of the provider-required forms will be auto-filled without the need for the parent or guardian to re-input the details which have not changed.

In this fashion, for each provider in the system, parent or guardian users need only input data concerning the child once to the system-provided template and, if nothing changes, the information is easily communicated into the patient or client forms of each provider in the proper format and location on the provider form. Medical or physicians' reports can also be uploaded and held in the provider database correlated to the child. Thereafter, for each chosen provider, the system will communicate all of the test or report documentation to the chosen provider in one consolidated enrollment package. The concurrent populating of the provider patient or client form, using the correlating information from the system template form, will save both the parent and the provider significant time and the costs related thereto.

In an especially preferred step, to automate any needed communications between the service provider and the parent or guardian of a child, the system will provide pre-populated messaging. In this step, a provider may communicate an update or question or appointment change opportunity to a respective parent or guardian for a response. Conversely, the pre-populated messaging can allow the parent or guardian to send messages to the providers.

Further, the system herein can operate to employ a formula or algorithm which will sort the service or product providers within the displayed search results. A graphic interface, presented to the user parent or guardian will allow them to input their preference for a provider based on availability, responsiveness, and how recently active a provider has been on the system. This is preferred, as it will increase the chance users will find a responsive provider.

Additionally preferred in the system herein is the provision of results of providers which meet the user inquiry in a graphic interface, such as a table allowing comparison of the provider. The graphic interface will preferably depict many elements of the service of each provider on a single page. This allows the user parent or guardian to easily compare the providers in any search to ascertain which provide the most desired elements by the user. For example a geographic locale, a responsiveness score, a fee comparison, and other desirable elements can be depicted in columnar fashion allowing for an easy comparison.

In an especially preferred mode of the system herein, the option for parent or guardian users to share the available time of a chosen service provider is provided. In this mode of the system, where two or more parent users communicate that service provider sharing is acceptable, the system will calculate the available hours of the chosen service provider for both parties and the desired provision of hours each parent user wants, and then start enrollment for both of the children with the chosen service provider for the respective hours and days each of the two wishes. This is a most preferred step in that it will allow parent and guardian users to book only the time of the service provider (such as a nanny), which they each require and will allow the service provider to sell more time.

In all modes of the system and steps herein noted, the system provider will employ network accessible servers or computers having accessible electronic memory for storage and retrieval of electronic database information relating to each child and each service provider or each product provider, correlating to the stated task or step or requirement of the operation noted to be performed by the software. Software, running in electronic memory, will operate to perform each step or task or calculation herein based on the matching or calculation of the service or product requirements of a child to providers for such products and services.

As to electronic memory or computer readable media for the system herein, any combination of one or more computer-usable or computer-readable media, be it transitory or non-transitory, may be employed for operation of the software and the provider assessment system herein. Such, for example and in no way limiting, can include computer-readable media and may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations and airflow assessments of the present invention may be written in any combination of one or more programming languages.

The steps or method of operation and/or execution of the various modes and tasks of the system herein may be illustrated as blocks or steps in the drawings which may represent one or more sequences in the operation of the steps and assessments in the system herein. These operations or steps can be implemented in hardware, software operating to process input data to accomplish the task or step, or a combination thereof.

With regard to software operating to a task or steps or assessments indicated in the system herein, such represents computer-executable instructions stored upon one or more transitory or non-transitory computer-readable storage media, which, when executed by one or a plurality of processors, will operate to perform the recited task, assessment, operation or step. Computer-executable instructions, in general, include routines, programs, algorithms, data structures, and the like which are configured to perform particular functions or to implement particular abstract data types or steps noted.

It should be noted that the sequence in which the steps of the system herein for matching service providers to children and the communication of information therebetween are not intended to be construed as a limitation. It should be understood that any number of the described or designated steps can be combined in any order and/or in parallel to implement the described and depicted matching assessments and processes. In some modes of the system herein, one or more steps can be rearranged or omitted entirely. Still further, the software-enabled steps in the system herein can be combined in whole or in part with each other or with other steps or methods.

With respect to the above description, before explaining at least one preferred embodiment of the system and method of matching children in need of provisional services to providers of such, it is to be understood that the invention is not limited in its application to the details of operation nor the arrangement of the components or the steps set forth in the following description or illustrations in the drawings. The various methods of implementation and operation of the system and method herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other methods and systems for matching of child patients with service providers and for carrying out the several purposes of the present method. Therefore, that the objects and claims herein should be regarded as including such equivalent construction, steps, and methodology insofar as they do not depart from the spirit and scope of the present invention.

It is an object of this invention to provide a computer-implemented method employing software operating to the task of comparing desired or required professional services of a child to those services of system registered providers.

It is an additional object of this invention to provide a computer and software enabled system allowing for information input by a parent or guardian concerning a child which is auto populated to the new client enrollment forms or in the desired format of a chosen provider.

It is yet another object of this invention to provide a computer and software enabled system which customizes application templates presented to clients or users to match each of the current new client applications and forms of each respective service provider.

It is an additional object of this invention to provide users, such as parents, online enrollment forms which are constantly updated to meet the requirements of each state, to thereby maintain the providers in compliance with the respective requirements for such input and client forms, for the state or states in which they operate.

It is a further object of this invention to provide such an automated patient and provider matching system which allows two or more parent users to share the available time of a service provider.

These, together with other objects and advantages, which will become subsequently apparent, reside in the details of the operation of the system herein as more fully hereinafter described and claimed, reference being had to the accompanying drawings forming a part thereof, wherein like numerals refer to like parts or steps in the system throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some but not the only or exclusive examples of embodiments and/or steps of the computer and software enabled system herein. It is intended that the embodiments and figures disclosed herein are to be considered illustrative of preferred modes of the system rather than limiting.

In the drawings:

FIG. 1 depicts a first series of steps which may be employed in the system herein.

FIG. 2 shows a further extension of the steps of the system herein continuing from FIG. 1.

### DETAILED DESCRIPTION OF THE PREFERRED

### Embodiments of the Invention

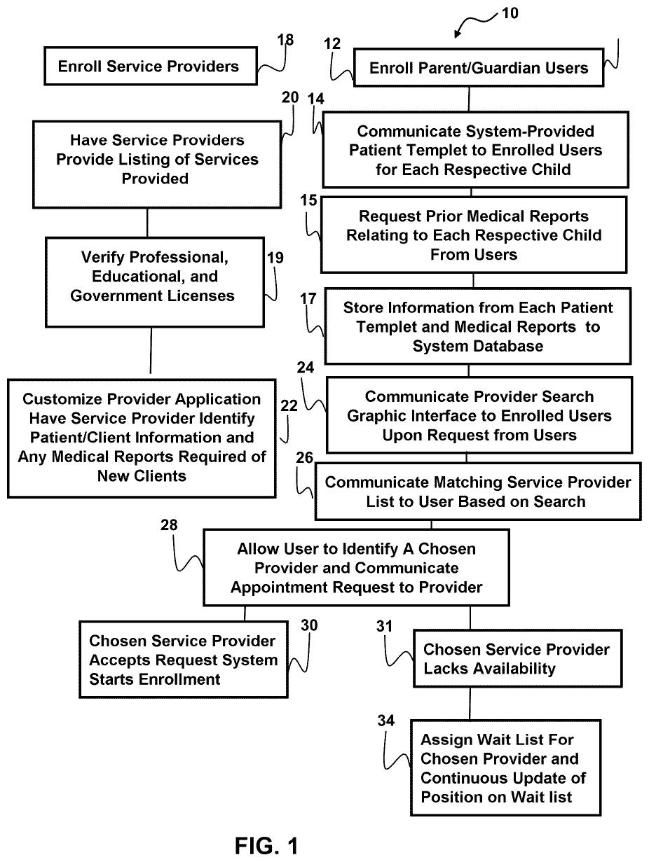

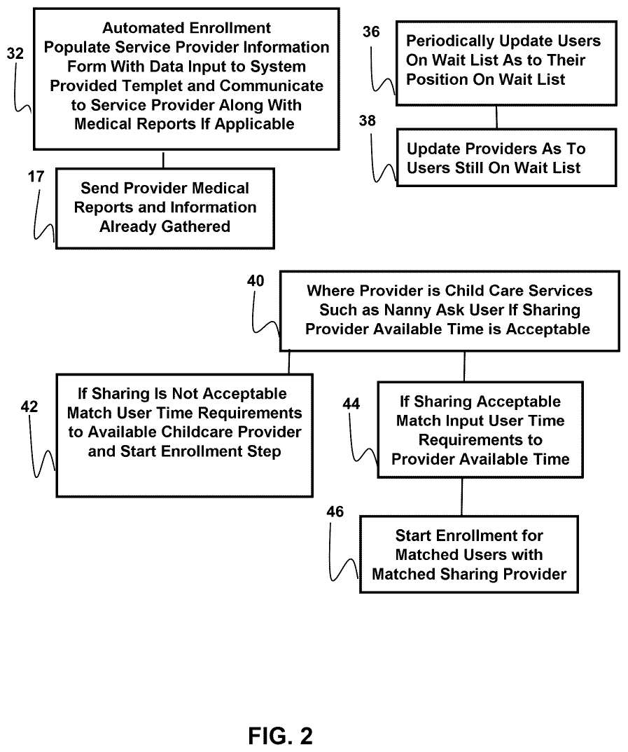

Referring now to the method and system 10 herein shown in simple format by the depictions of FIGS. 1 and 2, as noted above, software operating to the task of performing each step or task in the system 10 will operate on network-connected computers having such software operatively running thereon. Such computers, for example, may be mainframes, PC's smartphones, tablets, or other computers having an engaged graphic interface.

As shown in FIGS. 1-2 herein, the system 10, in a first step, will operate over a network in communication with computer devices of the parents or guardians 12 of the child or children for whom they will be subsequently seeking service providers. During enrollment, the information concerning the party signing up as a parent or guardian, their address, the names and other information of the child or children for whom they are responsible, and other information concerning the user parent or guardian will be input and will be communicated to the parent and child relational database of the service provider.

For each respective child for which the user parent or guardian has identified as being associated, the system 10, in another step 14, will communicate to the user parent or guardian a child information template which will include fields for information entry. For each respective child associated with the parent or guardian, the system will communicate a patient template 14. The use of the term “patient” herein is not intended to limit the services provided to medical but can include any service a service provider has to offer for children, such as nanny services.

The parent or guardian will populate the fields of the provided information template with child information concerning the child to which that template will relate. Such child information includes, for example, name, age, gender and other factors which a service provider will need for their new patient forms. For each child associated with each parent or guardian, the child information input into the template will be stored in a patient information database of the system provider for use, as noted herein, to populate the chosen service provider information forms.

In a sub step of inputting patient information, the system may also request copies of prior child medical reports 15 for each child patient. Such information is generally state mandated and can be also employed subsequently to populate the required information fields.

These reports and the information regarding each patient input into the patient template may be stored in the database and associated with each respective patient 17. This patient information and related reports will be subsequently communicated to requesting service providers, as needed.

In another step in the system 10, service providers will be enrolled 18. Such enrollment will include input of information by the service providers at least as to their geographic location for providing services and any government or professional requirements they have to provide such services. In an optional step to this service provider enrollment 18, the system may take the step of verifying the professional, educational, and government licenses and the like that are input by the professional during enrollment 19.

Once the enrollment of the service providers 16 is accomplished, each provider will, preferably, input to the system the type of services they professionally provide 20 along with available hours for such provision. The available hours can be continuously updated by the service provider. The geographic area wherein the service provider will provide the listed service may also be included, so as to be able to sort requested services for user by both those available and the geographic area of the parent or guardian user.

The input services a provider can provide to users requesting such will be associated to the respective professional provider and stored in a provider service database wherein either the services or the providers associated with such services, in the identified geographic area, may be searched by the system 10.

Once the professional providers are enrolled 18 and their respective provided services are input and stored in the database, relating each service to a respective professional provider, the system 10 will communicate to the service provider an exemplar of the system standard patient template which is to be filled out by each parent or guardian user in relation to each child patient.

In an especially preferred step in the system 10 each service provider will identify the provider information or fields 22 of the patient information template having the child information which is filled out for each child, which that respective service provider needs for their in house provider patient form. This step allows each service provider to accept online applications from prospective parent or guardian users through the application and to customize the application template, either presented to the parent or user, to be able to capture the provider information which each respective service provider requires to be able to take on or review candidates and determine if they are a good fit for their facility. Further, once a patient or child is accepted by a service provider, the required provider information for the provider's new client information form is provided by the system using the previously identified required child information fields from the provider. This will significantly decrease the administrative time for each provider. The system can pre populate the provider patient form for each provider with the respective child information they identify as required.

This service provider identification of required provider information 22 for new clients or patients will allow the system provider, in the future, to communicate a patient enrollment or information form to each service provider, which is already populated with the child information they have identified as required for in house provider patient forms.

In a preferred step in the system 10, the provided online enrollment forms will be constantly updated to thereby meet the requirements of each state. The enrollment forms, correlated to the requirements of each state and each provider therein, will be maintained in a database which is continuously updated. This step is preferred to maintain the service providers in compliance with the respective requirements for such enrollment and new client forms for the respective states in which they may be licensed or operate.

Registered users such as parents and guardians will, once logged into the system 10, be able to search for service providers. This search step is best enabled by the communication of a graphic interface 24 to the computer display of the users which allows those users to search for a provider of a specific service, and optionally in a particular geographic area. The graphic interface can also include any search criteria which the system provider and users consider relevant to finding an appropriate service provider and, of course, is not limited to just services and geographic location.

Upon the input of data to the fields of a graphic interface by a user, for searching of providers and the communication of such to the system provider server, the computer server of the system provider will employ the input search parameters data to stored enrolled service providers and ascertain one or a plurality of service providers which meet the search prerequisites. The results, in the format of matching service providers for the inquiring user, are then communicated 26 to the user.

The user, from the communicated listing of one or more matching service providers, will then choose a service provider 28, and the system herein will communicate an appointment request to the system and to the one or plurality of chosen service providers. Such may be accomplished by checking a box on a graphic interface or other computerized means for indicating a choice of a chosen service provider. The chosen service provider will then be communicated a request for an appointment.

The service provider may then choose to accept the request for an appointment 30. If an acceptance is communicated to the system provider and the user by the service provider, the system will then use the child information input to the patient template 14 for the child, to automatically populate the fields on the service provider patient information form in an automated enrollment of the child with the service provider 32, and such will be sent to the service provider electronically. Such acceptance by a service provider can include the communication of e-forms for a signature by the new client and/or the service provider which can be accomplished online using an e-signature service.

An additional preferred step, at this juncture, in order to reduce the enrollment workflow for both user and provider, after the parent or other users execute and required enrollment forms, they will be given the option or in some cases the required task to upload additional documents which are required by the service provider or the state for enrollment.

To that end, a step providing for the communication of the child medical reports gathered from the input of the child medical reports 15, such the child's vaccination records, any required physician's report on the child, and/or a customized or state-required contract may be provided to the service provider 39. This step insures that all forms and medical information relating to child enrollment are filled out as required and then sent to the provider in one consolidated package.

In an optional but preferred step of the system 10, it is anticipated that some registered service providers may lack service provider availability 31. In such cases, the system 10 herein will operate to form a waiting list for each user requesting the services of each such provider 34. This will allow the registered service providers to adapt or enlarge their schedule to accommodate more patients or clients and to contact those on the waiting list to schedule appointments.

The users, once included to the waiting list, may continuously review it to update their position in the queue. As individuals are taken off the wait list, when receiving appointment times, the remaining users of the system on the waiting list can be notified or can sign onto the service provider site and be updated as to their current position on the waiting list 36. This step is preferred as it insures transparency in the system, so users can see their progress. This will allow them to either seek another service provider, if time becomes an issue, or to continue to wait for an appointment with the knowledge of their current position on the list.

Concurrently to forming and maintaining the waiting list 34, the system will operate to continually inform providers who have clients or potential clients or patients on the waiting list, as to those on a waiting list for their services 38. This will allow the providers again to adjust their service schedule to accommodate those on the waiting list, if possible, and to know which of their current patients or clients are on the waiting list. This information can be important to the service provider should they discern someone is on the waiting list who they know may need services more quickly so they can accommodate them or suggest alternate providers to them for service.

As noted, in an especially preferred step of the system 10 herein, the parent or guardian user may be queried if they wish to consider sharing the time of a chosen service provider 40. This will allow two or more users to combine their respective needs for the time of a service provider.

If sharing is not indicated as acceptable 42 then the system will initiate the automated enrollment 32 for a single user to the identified chosen service provider. If the two or more users have both accepted sharing for a chosen a respective service provider, the system matches to individual times for each user requesting sharing to times available by the chosen service provider 44. Thereafter, the system will initiate automated enrollment 46 for each of the children of the two or more users in the same fashion noted above.

While all of the fundamental characteristics and features of the system for matching children as clients or patients to service providers have been shown and described herein, with reference to particular embodiments thereof, a latitude of modification, various changes and substitutions are intended in the foregoing disclosure and it will be apparent that in some instances, some features or steps of the disclosed system may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention herein disclosed.

What is claimed is:

1. A computer implemented system matching children needing professional services to service providers of such services comprising:
a processor, and
a non-transitory, computer readable medium communicably coupled to the processor and storing instructions which, when executed by the processor, cause the processor to perform operations comprising:
enrolling parents or guardians of a child as a user;
enrolling service professionals as service providers;
having each service provider provide a listing of services they provide for children;
communicate a patient template to each user for input by said user of child information of the child said user is associated with;
store in electronic memory the respective child information associated with each respective child of each user;
having each service provider identify portions of said child information they require for a service provider information form, for each child for which they provide services;
allow users to search for a service provider who provides desired services from said listing of services provided by said service providers;
in response to said search, provide said user a matching listing of said service providers who can provide the desired services;
from said listing of service providers having said user designate a chosen service provider;
communicating a request to said chosen service provider to provide services for said user;
subsequent to an acceptance of said request by said chosen service provider initiate an automated enrollment with said chosen service provider for said child of said user.

2. The computer implemented system of claim 1, additionally comprising the steps of:
during said automated enrollment populating said service provider information form with said portions of said child information identified as required using said child information input by said user associated with said child.

3. The computer implemented system of claim 1, additionally comprising the steps of:
verifying any professional, educational, and government licenses required by each respective service provider and forming a service provider verification before allowing said service provider to provide said services listed as provided.

4. The computer implemented system of claim 2, additionally comprising the steps of:
verifying any professional, educational, and government licenses required by each respective service provider and forming a service provider verification before allowing said service provider to provide said services listed as provided.

5. The computer implemented system of claim 1, additionally comprising the steps of:
subsequent to a denial of a said request to said chosen service provider to provide services for said user, assign said user to a wait list for said chosen service provider;
periodically updating each said user on said wait list of their current respective position thereon;
allowing each respective said user placed on said wait list to review their position thereon at will;
continuously updating service providers of users designating them as a chosen service provider who are on said wait list; and
removing said users on said wait list once said chosen service of a user accepts their request to provide services for said user.

6. The computer implemented system of claim 2, additionally comprising the steps of:
subsequent to a denial of a said request to said chosen service provider to provide services for said user, assign said user to a wait list for said chosen service provider;
periodically updating each said user on said wait list of their current respective position thereon;
allowing each respective said user placed on said wait list to review their position thereon at will;
continuously updating service providers of users designating them as a chosen service provider who are on said wait list; and
removing said users on said wait list once said chosen service of a user accepts their request to provide services for said user.

7. The computer implemented system of claim 4, additionally comprising the steps of:
subsequent to a denial of a said request to said chosen service provider to provide services for said user, assign said user to a wait list for said chosen service provider;
periodically updating each said user on said wait list of their current respective position thereon;
allowing each respective said user placed on said wait list to review their position thereon at will;
continuously updating service providers of users designating them as a chosen service provider who are on said wait list; and
removing said users on said wait list once said chosen service of a user accepts their request to provide services for said user.

8. The computer implemented system of claim 1, additionally comprising the steps of:
inquiring from said user if sharing of the services of said chosen service provider with at least one additional user is acceptable;
having each user, sharing said service, input times desired for provision of said services by said service provider;
matching said input times desired for provision of service to available times for said chosen service provider;
subsequent to an acceptance of said request by said chosen service provider for the times to provide services for both users, initiate an automated enrollment with said chosen service provider for each said child of each said user.

9. The computer implemented system of claim 2, additionally comprising the steps of:
inquiring from said user if sharing of the services of said chosen service provider with at least one additional user is acceptable;
having each user, sharing said service, input times desired for provision of said services by said service provider;
matching said input times desired for provision of service to available times for said chosen service provider;
subsequent to an acceptance of said request by said chosen service provider for the times to provide services for both users, initiate an automated enrollment with said chosen service provider for each said child of each said user.

10. The computer implemented system of claim 3, additionally comprising the steps of:
inquiring from said user if sharing of the services of said chosen service provider with at least one additional user is acceptable;
having each user, sharing said service, input times desired for provision of said services by said service provider;
matching said input times desired for provision of service to available times for said chosen service provider;
subsequent to an acceptance of said request by said chosen service provider for the times to provide services for both users, initiate an automated enrollment with said chosen service provider for each said child of each said user.

11. The computer implemented system of claim 5, additionally comprising the steps of:
inquiring from said user if sharing of the services of said chosen service provider with at least one additional user is acceptable;
having each user, sharing said service, input times desired for provision of said services by said service provider;
matching said input times desired for provision of service to available times for said chosen service provider;
subsequent to an acceptance of said request by said chosen service provider for the times to provide services for both users, initiate an automated enrollment with said chosen service provider for each said child of each said user.

12. The computer implemented system of claim 1, additionally comprising the steps of:
allowing users to designate a geographic area for said service provider; and
allowing users to search for a service provider in said geographic area who provides desired services from said listing of services provided by said service providers.

13. The computer implemented system of claim 8, additionally comprising the steps of:
allowing users to designate a geographic area for said service provider; and
allowing users to search for a service provider in said geographic area who provides desired services from said listing of services provided by said service providers.
